(19) United States
(12) Patent Application Publication
(10) Pub. No.: US 2018/0141255 A1
(43) Pub. Date: May 24, 2018

(54) FOAMING MESH EXTRUSION AND METHOD FOR MAKING SAME

(71) Applicant: Vintech Industries, Inc., Imlay City, MI (US)

(72) Inventors: James Schoonover, Shelby Township, MI (US); Robert Rutoski, Imlay City, MI (US)

(21) Appl. No.: 15/821,360

(22) Filed: Nov. 22, 2017

Related U.S. Application Data
(60) Provisional application No. 62/425,434, filed on Nov. 22, 2016.

(51) Int. Cl. B29C 47/00; B29C 47/08

(52) U.S. Cl. CPC B29C 47/0042; B29C 47/0004; B29K 2063/00; B29C 47/0064; B29C 47/08

(57) ABSTRACT

An extruded mesh that is activatable at predetermined temperatures for expansion when desired and a method for manufacturing same. The process includes providing an extrusion tool assembly where the flow of the polymer is interrupted intermittently to allow for the gaps in the mesh in the extrudate to assist with expansion.

### CROSS REFERENCE TO RELATED APPLICATIONS

This application claims the benefit of U.S. Provisional Application No. 62/425,434 filed Nov. 22, 2016.

### FIELD OF THE INVENTION

The present invention relates to an activatable foaming mesh extrusion and process for manufacturing same.

### BACKGROUND OF THE INVENTION

Expandable adhesive materials for sealing, baffling, sound dampening, reinforcing or structural bonding are known, such as for use in the automotive industry where adding as little weight to the vehicle as possible is strongly desired. One such known material is described in U.S. Pat. No. 6,846,559 B2, which patent is incorporated herein as part of this patent specification. The adhesive material is formed into a thick solid sheet which expands when heated. Typically the sheet is a rolled solid sheet that expands to fill cracks in response to heat. One application is use of the material in automotive in which the material is applied in an unexpanded state and then added heat in the painting process expands the material to a greater volume (100% greater, 500% greater, 1000% greater, 2000% greater or 5000% greater). FIG. 1 depicts a known expanded member that can attach to two parts.

Therefore, it is desirable to have a seal and method for making same, which has a closed cell structure and honeycomb profile that provides a higher tear strength, more uniform density and repeatability and which does not absorb moisture, and without compromising the mounting and sealing characteristics.

### SUMMARY OF THE INVENTION

The present invention is generally directed to extruded mesh or “netting” and method of manufacturing the extruded mesh, e.g., an extruded mesh for automotive sealing, etc. The mesh includes a strip with gaps formed in both the horizontal and vertical directions. The mesh material is extruded and operably formed. In an embodiment of the present invention, at least one attachment feature is added or otherwise integrated with the strip. According to one embodiment of the present invention, hooks (e.g., seal hooks) or clips are co-extruded into the mesh. The mesh is expandable a predetermined amount with activation, e.g., heat activation, at predetermined temperatures. In an embodiment of the present invention, the mesh is a heavy-duty screen. The mesh has several advantages, including, that the mesh uses less material to manufacture than the thick solid sheets of conventional systems, and that the gaps assist with expansion in the horizontal and/or vertical directions.

The process for making the mesh includes processing/extruding the material for the mesh at a predetermined lower temperature, e.g., at room temperature. Preferably, the temperature is between about ambient temperature and the higher temperature needed for expansion (e.g., 300 degrees F.). Preferably, the mesh material is also extruded at predetermined low pressure. The mesh can be used for a product in a paint oven (e.g., such as an automobile), etc. The size of the netting is adjustable to accommodate packaging area or other attachment(s) for attachment in a vehicle. The material is also adjustable so that the part is not expanded.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an expanded adhesive;

FIG. 2 is a perspective view of an extruded mesh, according to an embodiment of the present invention;

FIG. 3 is a perspective view of an extruded mesh, according to another embodiment of the present invention;

FIG. 4 is a perspective view of an extruded mesh, according to yet another embodiment of the present invention;

FIG. 5 is a side elevation view of an expandable portion on both sides of a non-expandable portion, according to another embodiment of the present invention;

FIG. 6 is a side sectional view schematic of an extrusion tool and indicating the mandrel motion, according to an embodiment of the present invention; and

FIG. 7 is a side sectional view schematic of the extrusion tool including an eccentric cam, according to the present invention.

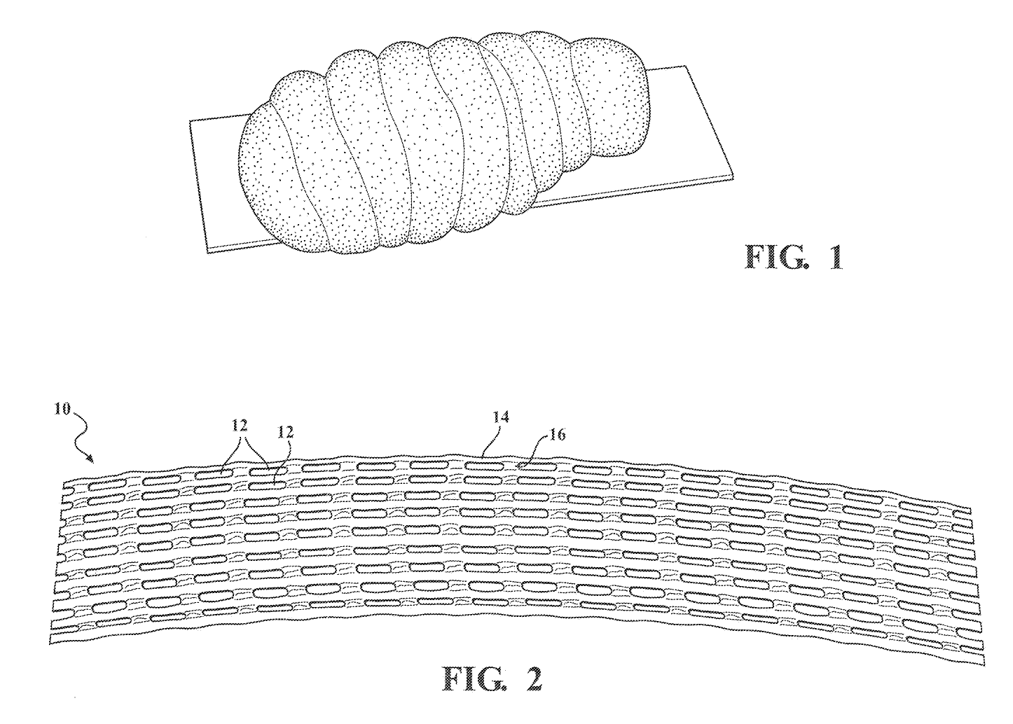

### DETAILED DESCRIPTION OF THE PREFERRED EMBODIMENTS

The following description of the preferred embodiment(s) is merely exemplary in nature and is in no way intended to limit the invention, its application, or uses.

Referring to the figures generally, in accordance with the present invention there is provided an extruded mesh and method of manufacturing same. The present invention is generally directed to extruded mesh or “netting” and method of manufacturing the extruded mesh, e.g., an extruded mesh for automotive sealing, etc. The mesh includes a strip with gaps formed in both the horizontal and vertical directions. The mesh material is extruded and operably formed. In an embodiment of the present invention, at least one attachment feature is added or otherwise integrated with the strip. According to one embodiment of the present invention, hooks (e.g., seal hooks) or clips are co-extruded into the mesh. The mesh is expandable a predetermined amount with activation at predetermined temperatures, e.g, heat activation at elevated temperatures. In an embodiment of the present invention, the mesh is a heavy-duty screen. The mesh has several advantages, including, that the mesh uses less material to manufacture than the thick solid sheets of conventional systems, and that the gaps assist with expansion in both the horizontal and vertical directions.

The process for making the mesh includes processing/extruding the material for the mesh at a predetermined lower temperature, e.g., at room temperature. Preferably, the temperature is between about ambient temperature and the higher temperature needed for expansion (e.g., generally 100-400°, typically 200-350°, preferably 250-325°, more preferably at least about 300° F., most preferably about 300° F.). Preferably, the mesh material is also extruded at predetermined low pressure. The mesh can be used for an end product in a paint oven (e.g., such as an automotive component), etc.

The size of the netting is adjustable to accommodate packaging area or other attachment(s) for attachment in a vehicle, etc.

Referring more particularly to FIG. 2 generally, a mesh member is shown generally at 10 (broken along its length to indicate the mesh member can be any predetermined length). The mesh member 10 is a generally strip-shaped material. However, any other formed shape is contemplated depending on the application without departure from the scope of the present invention. In addition, the mesh member 10 is any predetermined width and predetermined height depending on the application without departure from the scope of the present invention. Contoured and any other shapes are all contemplated depending on the application without departure from the scope of the present invention. While one mesh member 10 is shown, it is understood that more than one mesh member 10 and/or at least one attachment and/or at least one co-extruded seal, or any other extruded part or attachment and combinations can be integrated with the predetermined mesh member 10, depending on the application, according to the present invention.

A plurality of gaps 12 are formed throughout the mesh member 10 by both horizontal and vertical rows 14,16. The predetermined extruded material for forming the mesh member is suitable for the predetermined application and desired expansion, and any other desired properties, structural, processability, paintable, post-application processing, non-expanded properties, sealing, etc.

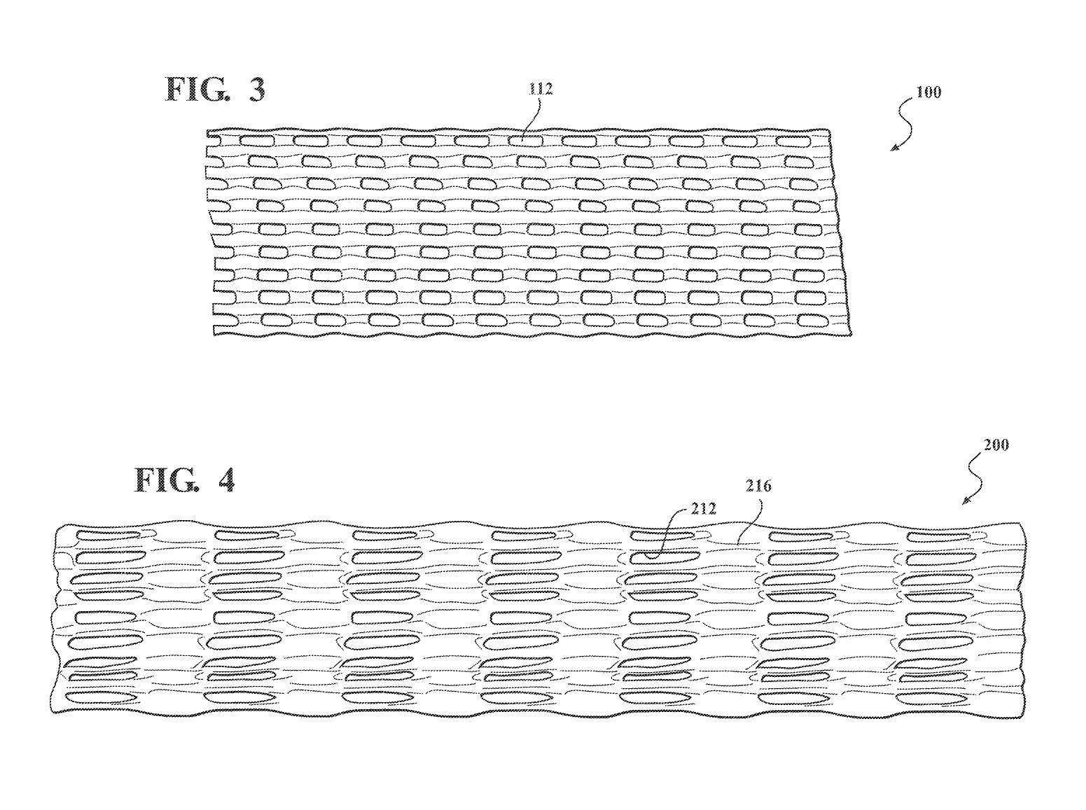

FIG. 3 is another mesh member 100, according to an embodiment of the present invention, with similar features (e.g., gaps 112) and advantages to the mesh member of FIG. 2. Further advantages are contemplated. The mesh member 100 and respective features have predetermined dimensions suitable for particular applications.

FIG. 4 is another mesh member 200, according to an embodiment of the present invention, with similar features and advantages to the mesh members of FIGS. 2 and 3. Further advantages are contemplated. The gaps 212 are generally longer than that shown in FIGS. 2 and 3. The vertical rows 216 are wider than that shown in FIGS. 2 and 3. The mesh member 200 and respective features have predetermined dimensions suitable for particular applications.

In general, the gaps 12, 112, 212 are about 0.15 to 1 inches long. Typically, about 0.2 mm to 0.75 inches long. Preferably, about 0.25 to 0.5 inches long. It is understood that shorter or longer gaps are contemplated depending on the application without departure from the present invention.

In general, the gaps 12, 112, 212 are greater than 1 mm wide. Typically, greater than 2 mm long. Preferably, about 1-5 mm long. Most preferably, about 2-4 mm wide. It is understood that that the width of the gaps can be more or less depending on the application without departure from the scope of the present invention.

In general, the thickness of the mesh member 10,100,200 is greater than 2 mm. Typically, about 0.25-2 inches. Preferably, about 0.2 mm to 1 inch. Most preferably, about 0.25-1 inch. It is understood that that the thickness of the mesh member can be more or less depending on the application without departure from the scope of the present invention.

Generally, the mesh member expands to about twice the size of the extrudate. It is understood that that greater or lesser amounts of expansion depending on the application are contemplated without departure from the scope of the present invention. The difference in volume between the expanded state or partially expanded state and the unexpanded state can be generally about 100% greater than the unexpanded state, about 500% greater, about 1000% greater, about 2000% greater or about 5000% greater, or higher, etc. It is understood that that greater or lesser amounts of expansion depending on the application are contemplated without departure from the scope of the present invention.

The expandable material in accordance with any expandable mesh member embodiment of the present invention is an activatable (e.g., heat expandable) material. The material includes an epoxy resin, an epoxy/elastomer hybrid or reaction product, a blowing agent, a curing agent, and optionally, a filler. In preferred embodiments, the material includes aramid fiber, nanoclay or both. It is understood that any suitable expandable material depending on the application may be used without departure from the scope of the present invention.

The epoxy resin is any of the conventional dimeric, oligomeric or polymeric epoxy materials containing at least one epoxy functional group. The polymer-based materials may be epoxy containing materials having one or more oxirane rings polymerizable by a ring opening reaction. In preferred embodiments, the structural adhesive material includes up to about 80% of an epoxy resin. More preferably, the expandable includes between about 10% and 70% by weight epoxy resin and still more preferably between about 40% and 60% by weight epoxy resin. The epoxy may be aliphatic, cycloaliphatic, aromatic or the like. The epoxy may be supplied as a solid (e.g., as pellets, chunks, pieces or the like) or a liquid (e.g., an epoxy resin). The epoxy may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Preferably, an epoxy resin is added to the expandable material to increase adhesion properties of the material. One exemplary epoxy resin may be a phenolic resin, which may be a novalac type or other type resin. Other preferred epoxy containing materials may include a bisphenol-A epichlorohydrin ether polymer, or a bisphenol-A epoxy resin which may be modified with butadiene or another polymeric additive. It is understood that any suitable epoxy or other suitable material depending on the application may be used without departure from the scope of the present invention. It is further understood that more or less epoxy may be used depending on the application without departure from the scope of the present invention.

An elastomer-containing adduct is employed in the composition of the present invention, in an embodiment of the present invention, and preferably in a relatively high concentration (e.g., on the order of the epoxy resin). The epoxy/elastomer hybrid or reaction product may be included in an amount of up to about 80% by weight of the expandable material. More preferably, the elastomer-containing adduct is approximately 20 to 50%, and more preferably is about 30% to 40% by weight of the expandable material. In turn, the adduct itself generally includes about 1:5 to 5:1 parts of epoxy to elastomer, and more preferably about 1:3 to 3:1 parts or epoxy to elastomer. The elastomer compound may be any suitable art disclosed elastomer such as a thermosetting elastomer. Exemplary elastomers include, without limitation natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. In one embodiment, recycled tire rubber is employed. The elastomer-containing adduct, when added to the expandable material, preferably is added to modify structural properties of the expandable material such as strength, toughness, stiffness, flexural modulus, or the like. Additionally, the elastomer-containing adduct may be selected to render the expandable material more compatible with coatings such as water-borne paint or primer system or other conventional coatings. It is understood that any suitable elastomer or other suitable material depending on the application may be used without departure from the scope of the present invention. It is further understood that more or less elastomer or elastomer-containing adduct may be used depending on the application without departure from the scope of the present invention.

One or more curing agents and/or curing agent accelerators may be added to the expandable material. Amounts of curing agents and curing agent accelerators can, like the blowing agents, vary widely within the expandable material depending upon the type of cellular structure desired, the desired amount of expansion of the expandable material, the desired rate of expansion, the desired structural properties of the expandable material and the like. Exemplary ranges for the curing agents or curing agent accelerators present in the expandable material range from about 0% by weight to about 7% by weight. Preferably, the curing agents assist the expandable material in curing by crosslinking of the polymers, epoxy resins (e.g., by reacting in stoichiometrically excess amounts of curing agent with the epoxide groups on the resins) or both. It is also preferable for the curing agents to assist in thermosetting the expandable material. Useful classes of curing agents are materials selected from aliphatic or aromatic amines or their respective adducts, amidoamines, polyamides, cycloaliphatic amines, (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines or polyamides such as triethylenetetramine, diethylenetriamine tetraethylenepentamine, cyanoguanidine, dicyandiamides and the like. An accelerator for the curing agents (e.g., a modified or unmodified urea such as methylene diphenyl bis urea, an imidazole or a combination thereof) may also be provided for preparing the expandable material. It is understood that any suitable curing agent(s) or other suitable material(s) depending on the application may be used without departure from the scope of the present invention. It is further understood that more or less curing agent may be used depending on the application without departure from the scope of the present invention.

At least one filler is used in an embodiment of the present invention, including but not limited to particulated materials (e.g., powder), beads, microspheres, or the like e.g, silica, mica, silicate minerals, diatomaceous earth, glass, clay, talc, pigments, colorants, glass beads or bubbles, glass, carbon ceramic fibers, antioxidants, mineral or stone type fillers, thixotropic, clays from the kaolinite, illite, chloritem, smecitite or sepiolite groups, which may be calcined, talc, vermiculite, pyrophyllite, sauconite, saponite, nontronite, montmorillonite and the like or mixtures thereof. When employed, the fillers in the expandable material can range from 10% to 90% by weight of the expandable material. According to some embodiments, the expandable material may include from about 0.001% to about 30% by weight, and more preferably about 10% to about 20% by weight clays or similar fillers. Powdered (e.g. about 0.01 to about 50, and more preferably about 1 to 25 micron mean particle diameter) mineral type filler can comprise between about 5% and 70% by weight, more preferably about 10% to about 20%, and still more preferably approximately 13% by weight of the expandable material. It is understood that other fillers may be used depending on the application without departure from the scope of the present invention. It is further understood that more or less fillers may be used depending on the application without departure from the scope of the present invention.

It is contemplated that one or more other additives may be used depending on the application without departure from the scope of the present invention.

At least one fastener 302 is affixable in the mesh member, according to an embodiment of the present invention. The material is also adjustable so that the part is not expanded where desired (See FIG. 5). FIG. 5 illustrates an example of at least one fastener 302 extending through at least one non-expandable material portion 304 for connecting to a predetermined component. Expandable portions 306,308 are integrally formed with, or alternatively operably attached to, the non-extendable portion 304. The fastener 302 is a screw, bolt, hook or any other suitable fastener depending on the application. Alternatively, the at least one fastener 302 is affixed in at least one of the expandable portions 306 and/or 308, or, at least one first fastener is affixed in at least one of the expandable portions while another at least one fastener is affixed in the non-expandable portion.

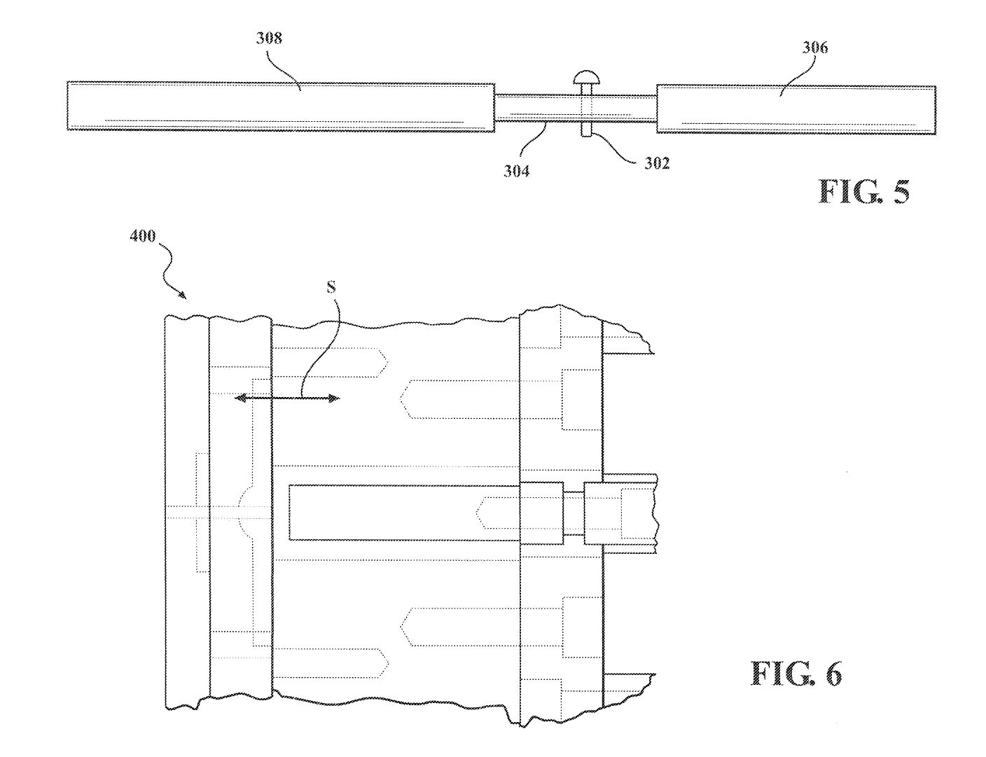

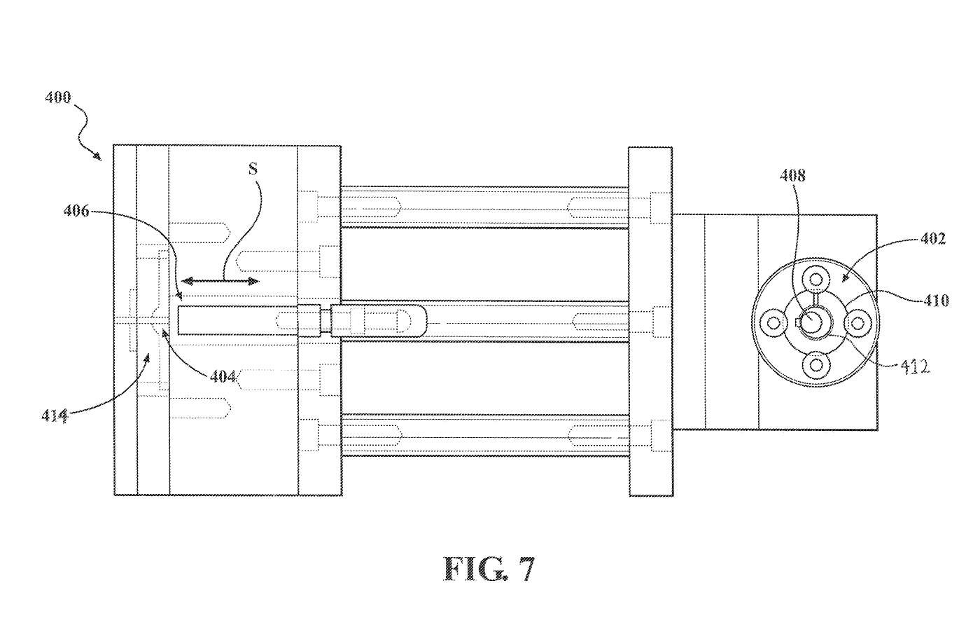

Referring now to FIGS. 6-7 generally, a foaming mesh extrusion process is provided, according to another embodiment of the present invention. In order to extrude a mesh member 10, the flow of the polymer is interrupted intermittently to allow for the gaps 12 in the extrudate (e.g., see FIG. 3).

An extrusion tool assembly shown generally at 400 is provided with at least one mandrel to “block” the flow inside the extrusion die. The mandrel needs to slide in and out of the polymer flow (indicated by “mandrel motion” arrow, “S”) using at least one motion mechanism shown generally at 402 to cause the at least one mandrel, indicated generally at 404, to move in/out of the flow at predetermined speeds depending on the particular applications. Generally, the motion mechanism 402 converts rotary movement to linear movement. Typically, the motion mechanism 402 incorporates a cam. Preferably, the motion mechanism 402 is a crank and eccentric cam mechanism. An electric gear motor powers the motion required for this process.

The speed of motion, e.g., speed of rotary movement, of the motion mechanism 402 causes the mandrel 404 is moved in/out of the polymer flow at a predetermined rate depending on the application. In addition, mandrel speed is a factor in determining the width, length and depth of the gaps 12,112,212 in the extrudate. Additionally, different widths and thicknesses of the extrudate depending on the application. By using the electric motor, e.g., servo motor and programmable logic controller (PLC), to move the motion mechanism 402 to thereby move the mandrel at predetermined ranges of speed, the mesh 10,100,200 can be defined depending on the particular applications. This also allows the creation of patterns (e.g., repeating patterns, sequence, gap orientations and locations in the mesh, gap shapes, gap dimensions, mesh contours, mesh shapes, mesh dimensions, etc) if required by particular applications.

The at least one mandrel 404 is caused to slide in and out of the polymer flow, indicated generally at 406, generally in the mandrel motion direction indicated by arrow “S”. The at least one mandrel 404 selectively interrupts the flow of material from at least one nozzle by selectively interrupting the flow of material inside the extrusion die at a predetermined rate depending on the application. Preferably, the mandrel 404 is a pin.

The mandrel 404 is operably caused to slide in and out of the polymer flow 406 with the motion mechanism 402, e.g., at least one crank and eccentric cam 402. By way of non-limiting example the eccentric cam 402 includes an offset pivot point 408 or axle, e.g., drive pin, that is operably driven to rotate by the electric motor to thereby cause rotation of at least one eccentric cam member 412 coupled to the offset drive axle 408, which rotation pushes/pulls at least one follower or at least one rod operably coupled to the eccentric cam member 412 toward one end and the at least one mandrel 404 toward another end. The pivot point 408 is generally off center on the eccentric cam member 412. At least one crank can be coupled to the at least one rod toward either end of the rod to help import desired motion of the at least one mandrel 404. Preferably, at least one collar or strap 410 is provided which is operably coupled to the eccentric cam member 412 and to the rod or crank such that as the eccentric cam member 412 rotates this causes pushing/pulling of the mandrel(s) 404 at a predetermined rate of speed depending on the application. By way of another non-limiting example the eccentric cam 402 includes an eccentric drive wheel, bearing and drive pin. It is understood that alternative motion mechanisms 402 suitable to cause movement of the at least one mandrel 404 in/out of the flow of molten material are contemplated depending on the application without departure from the scope of the present invention.

The predetermined dimensions and shape of the at least one mandrel 404 also affect the mesh formation. The extrusion tool assembly 400 is operable to allow changing out of mandrels 404 for different applications. The mandrel 404 chosen is determined based on the particular predetermined desired product parameters, e.g., desired mesh sizes and dimensions, gap dimensions, spacing, etc.). In addition, the extrusion tool assembly 400 is operable to allow changing out of at least one die plate 414. Preferably, desired changes to mesh sizes and thicknesses can be changed by making quick changeable tools.

Generally, the mesh size is controllable by the mandrel tooth size (or any other suitable shape operable for desired formation of the gaps), at least one die plate thickness (die plate indicated generally at 414), and the speed of the motion of the mandrel 404 in/out of the polymer flow. By changing any of these variables and combination of variables, a loose pattern or a tight pattern can be made. This is determined by the part's function in its environment.

The extrudate leaving the extrusion tool assembly 400 can be a continuous piece that is cut to predetermined length. By way of non-limiting example, the continuous strip can be rolled and processed in another area or an in-line cutter can cut the pulled continuous strip to length.

The extrusion tool assembly can also include a first plate and a second plate as part of the extrusion tool assembly, said first and second plate are operably connected together. A profiled opening can be provided in the second plate to provide a final outer profile of the extruded seal. In accordance with another embodiment, a plurality of pins that are vented can be operably connected to the first plate such that when the material is extruded, the material flows around the plurality of pins to produce the mesh structure.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. An extruded mesh, comprising:
at least one mesh member expanded in at least a horizontal and vertical direction, said mesh member formed of a predetermined expandable material operable for predetermined desired expansion in at least the horizontal and vertical directions at a predetermined temperature; and
a plurality of gaps formed in the expanded mesh member in a predetermined repeating pattern.

2. The extruded mesh of claim 1, wherein said predetermined expandable material is an activatable material including at least one epoxy, at least one elastomer, at least one blowing agent, at least one curing agent, and, optionally, at least one filler.

3. The extruded mesh of claim 1, wherein the plurality of gaps are operable spaced to assist with the expansion of the at least one mesh member in the horizontal and vertical directions.

4. The extruded mesh of claim 1, wherein the plurality of gaps are arranged in a plurality of parallel rows.

5. The extruded mesh of claim 1, wherein the plurality of gaps are aligned in a plurality of parallel columns.

6. The extruded mesh of claim 1, wherein the plurality of gaps are slots through the at least one mesh member.

7. The extruded mesh of claim 1, wherein the plurality of gaps are each about 0.25 to 1 inches long.

8. The extruded mesh of claim 1, wherein the plurality of gaps are each at least about 0.2 mm wide.

9. The extruded mesh of claim 1, further comprising at least one fastener affixed in the extruded mesh.

10. The extruded mesh of claim 1, further comprising at least one non-expanded mesh member integrally formed with or operably affixed to at least one of the at least one mesh member.

11. The extruded mesh of claim 10, further comprising at least one fastener affixed in the at least one non-expanded mesh member.

12. The extruded mesh of claim 1, wherein the at least one non-expanded mesh member comprises a plurality of expanded integral horizontal rows and vertical columns bounding the plurality of gaps.

13. The extruded mesh of claim 1, wherein the expandable material is activated to expand at a temperature of about at least 300° F.

14. The extruded mesh of claim 1, wherein the expandable material is extrudable at a temperature in the range of about ambient temperature to below 300° F.

15. The extruded mesh of claim 1, wherein the expandable material expands to provide a predetermined thickness of the at least one mesh member in the range of about 0.25 to 1 inches.

16. The extruded mesh of claim 1, wherein the expandable material is operable for operably affixing the at least one mesh member to an automotive part and expansion of the at least one mesh member in a paint oven at predetermined temperatures.

17. An activatable foaming mesh extrusion, comprising:
at least one mesh member formed of an activatable material comprising one or more of at least one epoxy, at least one elastomer or reaction product, at least one blowing agent, at least one curing agent, and optionally, at least one filler, said at least one mesh member expanded a predetermined amount by said activatable material;
a plurality of vertical and horizontal rows formed in the expandable mesh extrudate; and
a plurality of gaps operable to assist with predetermined expansion of the expandable mesh extrudate in at least the horizontal and/or vertical directions.

18. A method for making an expandable mesh, comprising:
providing an expandable material operable for extrusion at a predetermined temperature and operable for expansion at a higher predetermined temperature than the predetermined extrusion temperature, said expandable material comprising one or more of at least one epoxy, at least one elastomer or reaction product, at least one blowing agent, at least one curing agent, and optionally, at least one filler;
providing an extrusion tool assembly including at least one mandrel mechanism operable to move in/out of a flow of polymer material moving at a predetermined speed and pressure inside an extrusion die, said in/out movement operable to form a plurality of gaps in a mesh member;
providing at least one motion mechanism operably coupled to the at least one mandrel mechanism to provide said movement of the at least one mandrel mechanism in/out of the polymer flow at a predetermined speed of motion;
applying a flow of the polymer material to the at least one extrusion tool assembly and moving the at least one mandrel at the predetermined speed of motion in/out of the polymer flow, wherein the at least one mandrel intermittently blocks the polymer material flow to form the plurality of gaps;
extruding the polymer material through at least one die plate forming the extrudate including the mesh member with the plurality of gaps;
operably activating the mesh member to expand the mesh member a predetermined amount.

19. The method of claim 18, wherein the motion mechanism converts rotary movement to linear movement to cause said at least one mandrel to move in a longitudinal direction with respect to the polymer material flow.

20. The method of claim 18, wherein the motion mechanism includes an eccentric cam to operably convert rotary movement of the eccentric cam to linear movement of the at least one mandrel.

21. The method of claim 18, wherein the mesh member is activated by heating the mesh member to about at least 300° F. to expand the mesh member to predetermined dimensions.
